(19) United States
(12) Patent Application Publication
(10) Pub. No.: US 2002/0148769 A1
(43) Pub. Date: Oct. 17, 2002

(54) Spacer for membrane stacks

(76) Inventors: Andreas Deuschle, Nustinpeg (DE); Fred Reinhard, Mission Viejo, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/121,289

(22) Filed: Apr. 12, 2002

Related U.S. Application Data
(60) Provisional application No. 60/283,768, filed on Apr. 13, 2001.

(51) Int. Cl. B01D 63/08; B01D 25/00

(52) U.S. Cl. 210/321.75; 210/321.84; 210/231; 210/228

(57) ABSTRACT

In one embodiment, a membrane stack is described for separating dialysate and diffusate. The membrane stack comprises a plurality of membrane sheets and a plurality of spacers interspersed between the plurality of membrane sheets. Each spacer includes a gasket bordering a screen diagonally woven. These membrane sheets and spacers are affixed together by form a collective unit.

### 1. FIELD

The invention relates to the field of spacer technology for diffusion dialysis and electrodialysis.

### 2. GENERAL BACKGROUND

Currently, a conventional diffusion dialysis apparatus features a multiplicity of alternating ion selective, anion or cation selective membranes. This apparatus was apparently first described by K. Meyers and W. Strauss in 1940 (Ihelv. Chim. Acta 23 (1940) 795-800). However, the membranes used were poorly ion selective. The discovery of ion exchange (IX) membranes (U.S. Pat. No. Re.24,865), which have high ion perm-selectivity, low electrical resistance and excellent stability led rapidly to diffusion dialysis (DD) systems using such membranes (U.S. Pat. No. 2,636,852) and to the increased usage of DD systems for purification and recovery of acids in metal working industries.

During the last forty years, several thousand DD systems have been installed on a worldwide basis. However, a number of disadvantages are evident in conventional DD systems that can be overcome by the invention as described below. For example, the temperature expansion properties for a multiple element spacer are one cause of leakage in the DD systems.

### BRIEF DESCRIPTION OF THE DRAWINGS

The features and advantages of the invention will become apparent from the following detailed description of the invention in which:

FIG. 1 is an exemplary embodiment of a system employing the membrane stack.

FIG. 2 is an exemplary embodiment of the ion exchange conducted by the membrane stack of FIG. 1.

FIG. 3 is an exemplary schematic diagram of an embodiment of a membrane stack.

FIG. 4 is an exemplary diagram illustrating a transport mechanism associated with the membrane sheet of the membrane stack of FIG. 3.

FIG. 5 is an exemplary diagram illustrating a spacer of the membrane stack of FIG. 3.

### DETAILED DESCRIPTION

Herein, an exemplary embodiment of the invention relates to a spacer for a membrane stack and a technique for utilizing the membrane stack. The membrane stack may be utilized for diffusion dialysis (DD) or electrodialysis (ED). The embodiment described herein is not exclusive; rather, it merely provides a thorough understanding of the present invention. Also, well-known elements are not set forth in detail in order to avoid unnecessarily obscuring the invention.

In the following description, certain terminology is used to describe features of the invention. For example, a “spacer” is generally defined as a device that provides a generally defined distance between two adjacent membrane sheets for liquid to flow or move therebetween. A “membrane sheet” is generally defined as a thin section of material that allows chemicals of a certain chemical composition to permeate from one side to another, while other chemical compositions are precluded from passing through the material.

Advantages associated with the membrane stack described herein are numerous. For instance, the membrane stack provides enhanced performance by improved mass transfer, purification efficiency, and/or stack sealing properties. When employed in a system, the membrane stack provides more efficiently remove monvalent ions of one sign from liquids in preference to divalent ions of the opposite charge sign.

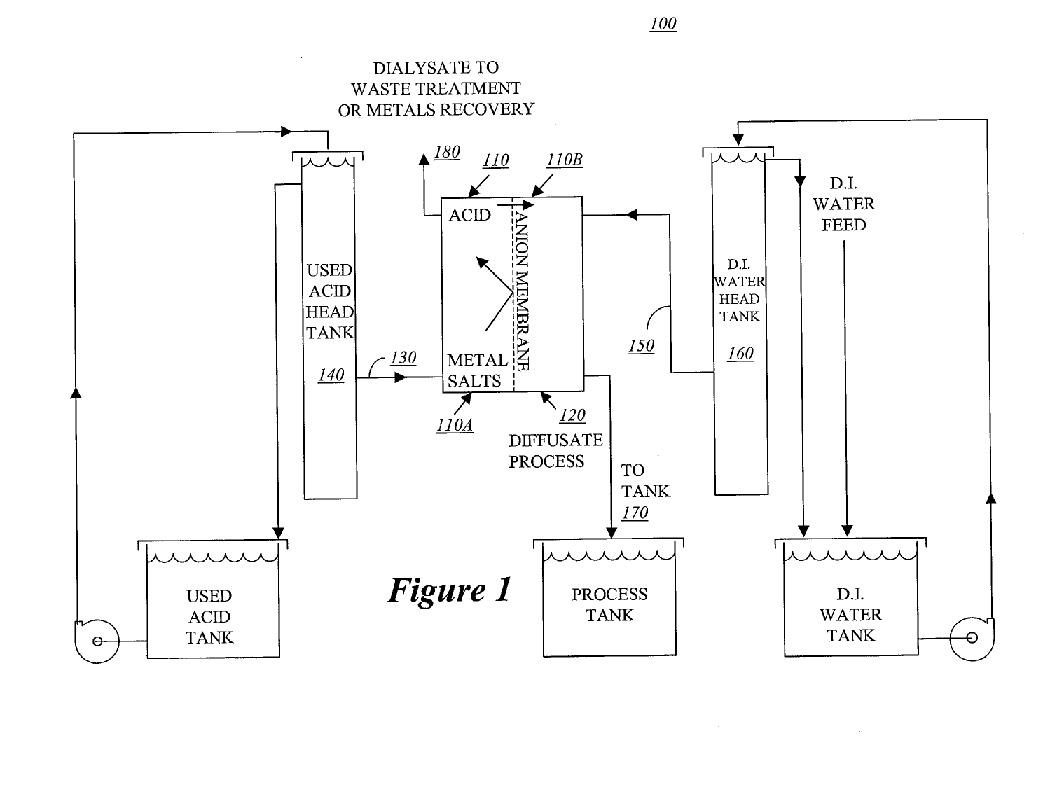

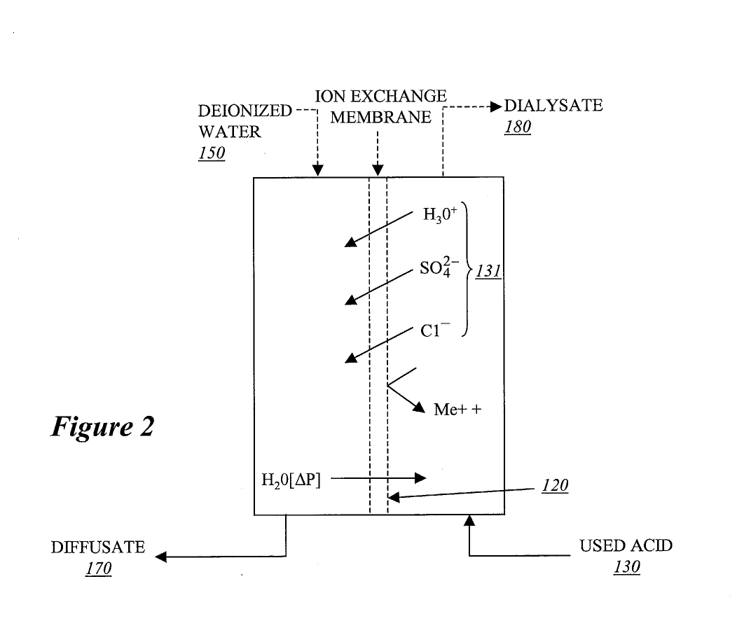

Referring to FIG. 1, an exemplary embodiment of a system employing a membrane stack in accordance with the invention is shown. The system 100 includes a cell 110 separated into two compartments 110A and 110B by a membrane 120. Used acid 130 (and perhaps at least one conjugate base 131 such as SO₄²⁻ or Cl⁻ as shown in FIG. 2) is provided to the first compartment 110A from a first head tank 140. Aqueous solution, such as de-ionized water 150, is provided to the second compartment 110B from a second head tank 160. The used acid 130 migrates through the membrane 120 (from the first compartment 110A to the second compartment 110B) while other aqueous solution (e.g., the de-ionized water 150 and resultant water after chemical reaction) flows through the second compartment 100B and absorbs acid that migrated from compartment 110A. The recovered acid 170 (referred to herein as “diffusate”) is collected in a process tank while dialysate (waste) 180 is provided for waste treatment or metals recovery.

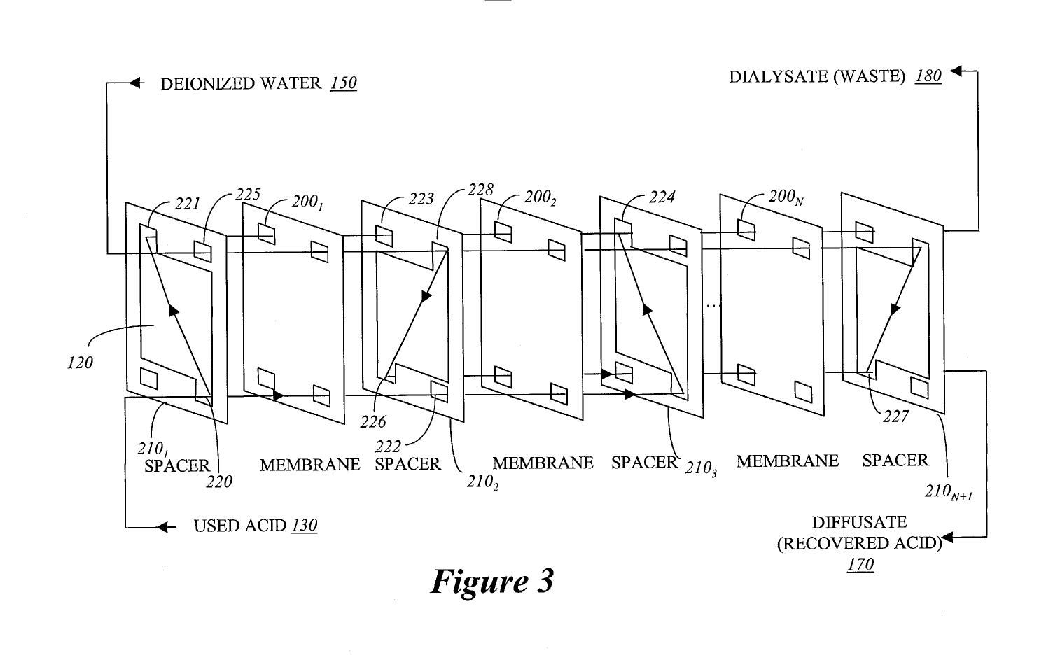

Referring now to FIG. 3, an exemplary embodiment of the membrane stack 120 comprises a plurality (N) of membrane sheets 200₁-200_{N}, which are alternatively separated by a spacer 210₁-210_{N+1}. Normally, the stack 120 is physically stabilized using two end plates and a hydraulic clamping unit, which do not impede the flow (not shown) and configured for optimal flow density (1/h m2). For this embodiment, besides membrane sheets 200₁-200_{N} and spacers 210₁-210_{N+1}, no other components (such as O-rings) are required to assemble the membrane stack 120 between the clamping unit. Other means for attachment of the sheets 200₁-200_{N} and spacer 210₁-210_{N+1} may include any mechanism for applying pressure to opposite ends of the stack 120.

Normally, each spacer (e.g., spacer 210₂) provides a defined distance between two adjacent membrane sheets 200₁ and 200₂ and a space for liquid to flow or move between membrane sheets 200₁ and 200₂. Normally, each spacer 210_{X} (“X”>1) is responsible for optimized fluid distribution between the membrane sheets 200₁-200_{N} and linear fluid velocity for optimized mass transfer. The mass transfer occurs between two liquids separated by a membrane sheet. As shown, spacer 210₂ is positioned flush against neighboring membrane sheets 200₁ and 200₂ for attachment therewith.

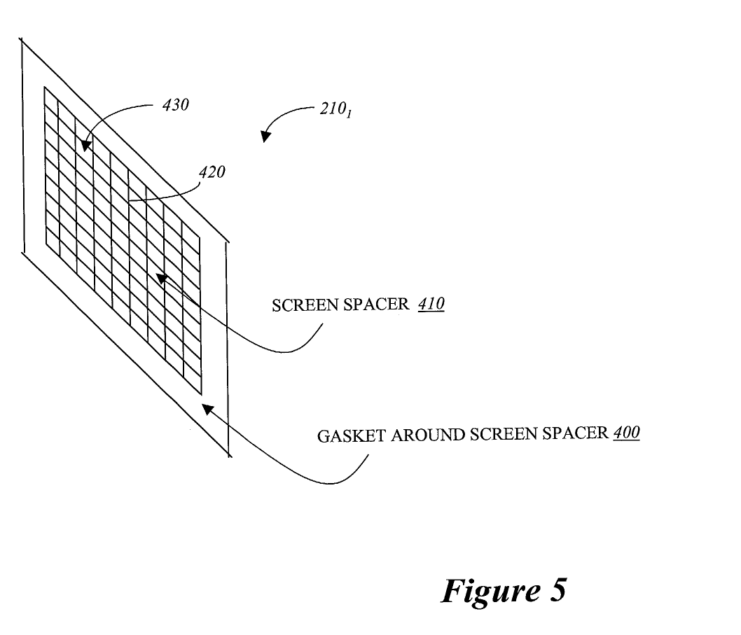

Herein, a spacer (e.g., spacer 210₂) comprises a single gasket 400 and screen 410 operating as a single collective unit as shown in FIG. 5. This “single unit” spacer 210₂ enables simple stack assembly, provides better pressure distribution, and provides an optimized blend of flexibility and sealing capabilities for fluid separation performance. The optimized thickness of the spacer 210₂ varies for industrial applications and it is not only important for system performance but also provides appropriate mechanical stability and properties for the distance between foil (gasket) and woven material (screen). The particular gasket materials are selected to provide good mechanical and stability properties at the interface between the gasket 400 and screen material 410. The optimized thickness of the spacer 210₂ may range from 0.1 to 1.2 millimeters and the particular materials of the gasket 400 may include, for example, a polymeric mixture with its base material made of PVC or polypropylene.

As shown in FIGS. 3 and 5, each spacer (e.g., spacer 210₂) includes at least one diagonally woven screen 410 that provides optimized flow characteristics. In one embodiment, strings 420 forming the screen 410 are woven at selected angles to form trapezium shaped openings 430 and each possesses a thickness of approximately 0.25 millimeters. Herein, the selected angle ranges from forty degrees (40°) up to fifty-five degrees (55°). Of course, other angles may be used besides ninety degree (90°) as used in conventional, rectangular screens. This angled screen configuration provides higher performance, perhaps 50-65% better performance, than the conventional (rectangular) screens. This optimizes fluid distribution and flux for high ion separation efficiency.

As further shown in FIG. 3, proximate to its first side, a first spacer 210₁ receives used acid 130 and alters the flow of the used acid 130 through both a first opening 220 and a second opening 221. Upon encountering the next spacer 210₂, the flow of the used acid 130 continues through openings 222 and 223. However, upon encountering the following spacer 210₃, the flow of the used acid 130 is altered to opening 224 to provide the used acid to a common outflow channel.

Additionally, as further shown, the first spacer 210₁ receives de-ionized water 150, which flows through a third opening 225. Upon encountering the next spacer 210₂, the flow of the de-ionized water 150 is routed through both the opening 228 and a fourth opening 226. Upon encountering the next spacer 210₃, the flow continues until a spacer 210_{N+1} is reached. Upon encountering the spacer 210_{N+1}, the flow of the de-ionized water 150 is altered to opening 227 to provide the de-ionized water to a common outflow channel for acid recovery.

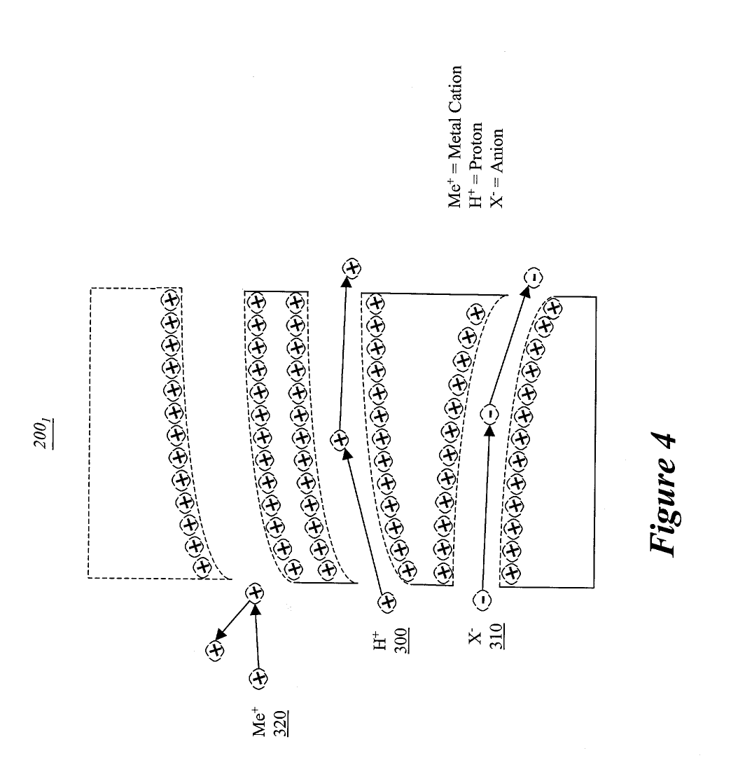

Referring to FIGS. 3 and 4, exemplary embodiments of the membrane stack 120 and the transport mechanism for a membrane sheet are shown. Separated by membrane sheets 200 that allow the migration of protons 300 and anions 310 through the membrane sheet 200 but not metal cations 320, each spacer 210_{X} comprises one in-flow and one outflow channel. Herein, every other membrane/spacer is designed in the same manner, with inflows and outflows connected to each other. Namely, the fluid or de-ionized water flows in and out of each spacer into an alternating fashion as shown. All inflows and outflows have a common inflow feed channel, and all outflows go into a common outflow channel, so all alternate connected spacers contribute liquid to one channel.

For ED use, for example, the membrane stack and its operating conditions allow for high current mass transfer and performance. Moreover, small distances between membrane sheets 200₁-200_{N} (<0.5 mm) allow for improved ion transportation rate and low diffusion resistance. Optimized fluid dynamics and high flow velocity provide high ionic concentrations in cell compartments. The high ionic concentrations allow high diffusion rates through the membrane sheets 200₁-200_{N}, and thus high performance.

In summary, optimized fluid dynamics (e.g., 45° screen orientation), optimized cell distance (high ionic conductance) and optimized cell flow rate (high mass transport rate) result in a enhanced stack design and performance, and significantly reduced leakage characteristics.

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. An apparatus comprising:
a plurality of membrane sheets; and
a first spacer interposed between at least two the plurality of membrane sheets, the first spacer including a gasket bordering a screen diagonally woven at a selected acute angle.

2. The apparatus of claim 1, wherein the screen is diagonally woven at the selected angle ranging from forty degrees to fifty-five degrees.

3. The apparatus of claim 1, wherein the screen includes diagonally woven strings forming trapezium shaped openings.

4. The apparatus of claim 1 further comprising:
a second spacer positioned adjacent to and flush with a first membrane sheet of the plurality of membrane sheets; and
a third spacer positioned adjacent to and flush with a second membrane sheet of the plurality of membrane sheets.

5. The apparatus of claim 4 further comprising:
a first end plate placed adjacent to the second spacer;
a second end plate placed adjacent to the third spacer; and
means for clamping the end plates together and applying pressure to the second and third spacers to hold at least the first, second and third spacers and the plurality of membrane sheets together as a single unit.

6. The apparatus of claim 4, wherein the second spacer includes a first opening to receive used acid and alters the flow of the used acid through both the first opening and a second opening oriented at an acute angle from the first opening.

7. The apparatus of claim 6, wherein the acute angle is substantially forty-five degrees.

8. The apparatus of claim 6, wherein the first spacer includes a third opening to receive aqueous solution and alters the flow of the aqueous solution through both the third opening and a fourth opening.

9. The apparatus of claim 8, wherein the third spacer includes a fifth opening to receive a flow of the used acid from the first opening of the second spacer to alter a flow of the used acid to a sixth opening that also receives a flow of the used acid originating from the second opening of the second spacer.

10. The apparatus of claim 9 further comprising:
a fourth spacer positioned between a third membrane sheet of the plurality of membrane sheets and the third spacer.

11. The apparatus of claim 10, wherein the fourth spacer to route the aqueous solution received from the third opening of the first spacer to an opening that receives a flow of aqueous solution from the fourth opening of the first spacer.

12. A membrane stack comprising:
a plurality of membrane sheets;
a plurality of spacers interspersed between the plurality of membrane sheets, each spacer including a gasket bordering a screen diagonally woven; and
means for affixing the plurality membrane sheets and the plurality of spacers as a collective unit.

13. The membrane stack of claim 12, wherein the screen of each spacer is diagonally woven according to a selected acute angle.

14. The membrane stack of claim 12, wherein the screen of each spacer includes diagonally woven strings forming trapezium shaped openings.

15. The membrane stack of claim 12, wherein the plurality of spacers include:
a first spacer positioned adjacent to a first membrane sheet of the plurality of membrane sheets;
a second spacer positioned adjacent to both the first membrane sheet and a second membrane sheet of the plurality of membrane sheets;
a third spacer positioned adjacent to both the second membrane sheet and a third membrane sheet of the plurality of membrane sheets; and
a fourth spacer positioned adjacent to the third membrane sheet.

16. The membrane stack of claim 15 further comprising:
a first end plate placed adjacent to the first spacer;
a second end plate placed adjacent to the fourth spacer; and
means for clamping the end plates together and applying pressure to the first and fourth spacers to hold membrane stack together as a single unit.

17. The membrane stack of claim 15, wherein the first spacer receives a first fluid, a second fluid and alters a flow of the second acid through both a first opening and a second opening oriented at an acute angle from the first opening.

18. The membrane stack of claim 17, wherein the second spacer includes a third opening to receive the first fluid and alters a flow of the first fluid through both the third opening and a fourth opening.

19. The membrane stack of claim 18, wherein the third spacer includes a fifth opening to receive a flow of the second fluid from the first opening of the first spacer and to alter a flow of the second fluid to a sixth opening that also receives a flow of the second fluid originating from the second opening of the first spacer.

20. The membrane stack of claim 19, wherein the fourth spacer to route the first fluid received from the third opening of the second spacer to an opening that receives a flow of the first fluid from the fourth opening of the second spacer.

21. A system comprising:
a first tank;
a second tank; and
a membrane stack coupled to receive fluids from the first tank and the second tank, the membrane stack including
a plurality of membrane sheets to separate the incoming fluids into dialysate and diffusate, and
a first spacer interposed between the plurality of membrane sheets, the first spacer including a gasket bordering a screen diagonally woven at a selected acute angle ranging from forty degrees to fifty-five degrees.

22. The system of claim 21, wherein the screen of the first spacer includes diagonally woven strings that form trapezium shaped openings.
